(19) United States
(12) Patent Application Publication
(10) Pub. No.: US 2026/0280853 A1
(43) Pub. Date: Sep. 17, 2026

(54) METHOD FOR SECURE PROCESSING OF INPUT DATA FROM A PLURALITY OF TERMINALS

(71) Applicant: Commissariat à l'Energie Atomique et aux Energies Alternatives, Paris (FR)

(72) Inventors: Renaud SIRDEY, Gif-sur-Yvette Cedex (FR); Jean-Paul BULTEL, Gif-sur-Yvette Cedex (FR)

(73) Assignee: Commissariat à l'Energie Atomique et aux Energies Alternatives, Paris (FR)

(21) Appl. No.: 19/563,745

(22) Filed: Mar. 11, 2026

(30) Foreign Application Priority Data
Mar. 11, 2025 (FR) FR2502431

(51) Int. Cl. H04L 9/08; H04L 9/00

(52) U.S. Cl. CPC H04L 9/0825; H04L 9/008; H04L 9/0894

(57) ABSTRACT

A method for secure processing of input data, comprising: obtaining a first data corresponding to an input data padded with a predefined padding block and homomorphically encrypted; for each first data, calculating a plurality of third data corresponding to the sum with a homomorphically encrypted random mask; for each third data, calculating a plurality of fourth data, each corresponding to the result of an attempt at homomorphic decryption of the third data with each decryption key, homomorphically re-encrypted; for each fourth data, calculating at least one fifth data corresponding to the difference with one of the random masks homomorphically re-encrypted; identification of the fifth data comprising a padding block coinciding with said predefined padding block; and application in the encrypted domain of a function corresponding to the desired processing from the fifth identified data.

### GENERAL TECHNICAL FIELD

The present invention relates to the field of homomorphic encryption. More specifically, it concerns a method for secure processing of input data from a plurality of terminals using the properties of the homomorphic encryption.

### STATE OF THE ART

Techniques for securing calculation by homomorphic encryption are known, allowing a server to perform a calculation on encrypted data without collecting any plaintext information about that data, or even about the result of the calculation. This is particularly desirable when working with sensitive and confidential data, such as personal data. For example, this is useful for a hospital seeking to process data relating to its patients.

To do this, homomorphic encryption is a cryptographic encryption such that, for a given calculation, it becomes possible to encrypt the data, perform certain calculations associated with said given calculation on the encrypted data, and decrypt them, obtaining the same result as if said given calculation had been performed directly on the plaintext data.

An encryption is referred to as “fully homomorphic encryption” (FHE) when it makes it possible to evaluate as many sequential additions or multiplications as desired in the encrypted domain, or even all operations of the space of the calculable functions.

The known homomorphic encryptions lead to satisfaction, but difficulties arise in a multi-user context, for example when processing involving data from several hospitals is desired.

Indeed, the data from two different users is homomorphically encrypted with two different keys, which therefore prevents working in the encrypted domain.

One idea to solve this problem is to use, in combination with the homomorphic encryption, a hardware security module, typically of the TEE (“trusted execution environment” type. This is often a secure enclave of a processor, but it may also be a dedicated element, as long as it is considered tamper-proof. And it is indeed already known in the context of homomorphic encryption to delegate part of the calculations to the TEE for performance reasons; see applications FR 2314410 and FR 2314913.

It is possible to store on this TEE the homomorphic decryption keys associated with each user so that it can decrypt the data of the users and re-encrypt them under a common key, which will allow the implementation, in the encrypted domain, of a processing involving any of these data.

The problem is that, even if the TEE is assumed to be trusted, it potentially has access to the decrypted data of the users (referred to as an “honest-but-curious” or “semi-honest” TEE, which in cryptography is a type of adversary that follows the protocol correctly, but tries to learn as much as possible from the available information).

Applications FR 2314410 and FR 2314913 propose masking techniques that improve the confidentiality by preventing any plaintext reading of the data of the users by the TEE. However, in a multi-user context, these techniques require the TEE to be able to link each input data to a public element specific to the user from whom it originates, and therefore do not guarantee anonymity.

It would be desirable to have a new multi-user secure calculation method based on the homomorphic encryption, that retains all the advantages of the known techniques in terms of security, reliability and data protection, and is additionally perfectly anonymous with respect to the users, i.e., in which no equipment and in particular no TEE may learn anything about the data or their origin.

### PRESENTATION OF THE INVENTION

The present invention therefore relates, according to a first aspect, to a method for secure processing of input data, the method being characterized in that it comprises the implementation of the steps:
(a) Obtaining, by data processing means of a server, from at least one client terminal of a set of client terminals each associated with a pair of an encryption key and of a decryption key stored by a hardware security module connected to said data processing means, a first data corresponding to an input data of said client terminal padded with a predefined padding block and homomorphically encrypted with the encryption key associated with said client terminal;
(b) For each first data, calculating, by the data processing means, a plurality of third data each corresponding to the sum of said first data and of a second data corresponding to a random mask of a set of random masks homomorphically encrypted with the encryption keys associated with each client terminal;
(c) For each third data, calculating by said hardware security module a plurality of fourth data, each corresponding to the result of an attempt at homomorphic decryption of the third data with each decryption key associated with one of said client terminals stored by the hardware security module, homomorphically encrypted with an encryption key associated with said hardware security module;
(d) For each fourth data, calculating by the data processing means at least one fifth data corresponding to the difference between said fourth data and a sixth data corresponding to one of said random masks homomorphically encrypted with the encryption key associated with said hardware security module;
(e) Identifying by the hardware security module the fifth data comprising a padding block coinciding with said predefined padding block.
(f) Applying by the processing means in the encrypted domain a function corresponding to the desired processing from the fifth identified data.

According to advantageous and non-limiting characteristics:

The encryption keys are public and the decryption keys are private.

Said homomorphic encryption is of totally homomorphic type, FHE.

Step (a) comprises the generation by data processing means of said client terminal of the first data and its transmission to said server.

Step (b) comprises the transmission to the hardware security module in a random order of the plurality of third data; and step (d) comprises the transmission to the hardware security module (3) in a random order of the plurality of fifth data or of the padding blocks of the plurality of fifth data.

The fifth data calculated for a fourth data corresponds to the difference between said fourth data and the sixth data corresponding to the same random mask as the second data from which this fourth data was calculated.

Steps (b), (c) and (d) respectively comprise the calculation of all possible third data, all possible fourth data, and all possible fifth data.

Step (e) comprises, for each fifth data, the generation by the hardware security module of a seventh data, denoted, having a first value if the fifth data comprises a padding block coinciding with said predefined padding block, and a second value otherwise.

Said first value of the seventh data is the value 1 homomorphically encrypted with the encryption key associated with said hardware security module, and the second value of the seventh data is the value 0 homomorphically encrypted with the encryption key associated with said hardware security module.

Step (f) comprises, for each first data, the calculation of an eighth data corresponding to the sum of each of the products of a fifth data calculated from this first data, without its padding block, by the seventh data calculated for this fifth data.

Said function corresponding to the desired processing is composed of operations compatible with said homomorphic encryption, step (f) comprising the application of said function directly to the eighth data.

Said hardware security module is a secure enclave of the data processing means.

Step (a) comprises the obtaining of a plurality of first data from a subset of client terminals of said set of client terminals, or even from all said set of client terminals.

The method comprises a step (g) of homomorphically decrypting, by the hardware security module and/or at least one of the client terminals, said result of the application of the function with the decryption key associated with the hardware security module.

According to a second aspect, the invention proposes a set of a server and of a hardware security module for secure processing of input data, characterized in that:
The server comprises data processing means configured to:
   Obtain, from at least one client terminal of a set of client terminals each associated with a pair of an encryption key and of a decryption key stored by a hardware security module connected to said data processing means, a first data corresponding to an input data of said client terminal padded with a predefined padding block and homomorphically encrypted with the encryption key associated with said client terminal;
   For each first data, calculate a plurality of third data, each corresponding to the sum of said first data and of a second data corresponding to an element of a set of random masks homomorphically encrypted with the encryption keys associated with each client terminal;
   For each fourth data, calculate at least one fifth data corresponding to the difference between said fourth data and a sixth data corresponding to one of said random masks homomorphically encrypted with the encryption key associated with said hardware security module;
   Apply in the encrypted domain a function corresponding to the desired processing from identified fifth data.
The hardware security module is configured to:
   For each third data, calculate a plurality of fourth data, each corresponding to the result of an attempt at homomorphic decryption of the third data with each decryption key associated with one of said client terminals stored by the hardware module, homomorphically encrypted with an encryption key associated with said hardware security module;
   For each fifth data, identify the fifth data that comprising a padding block coinciding with said predefined padding block.

According to third and fourth aspects, the invention proposes a computer program product comprising code instructions for the execution of a method according to the first aspect of secure processing of input data; and a computing equipment readable storage means on which is recorded a computer program product comprising code instructions for the execution of a method according to the first aspect of secure processing of input data.

### PRESENTATION OF THE FIGURES

Other features and advantages of the present invention will become apparent from reading the following description of a preferred embodiment. This description will be given with reference to the accompanying drawings, in which:

FIG. 1 is a diagram of a system for implementing the method according to the invention;

FIG. 2 is a flowchart illustrating the steps of an embodiment of the method according to the invention;

FIG. 3a illustrates a first part of an embodiment of the method according to the invention;

FIG. 3b illustrates a second part of an embodiment of the method according to the invention;

FIG. 3c illustrates a third part of an embodiment of the method according to the invention;

FIG. 3d illustrates a fourth part of an embodiment of the method according to the invention.

### DETAILED DESCRIPTION

### Architecture

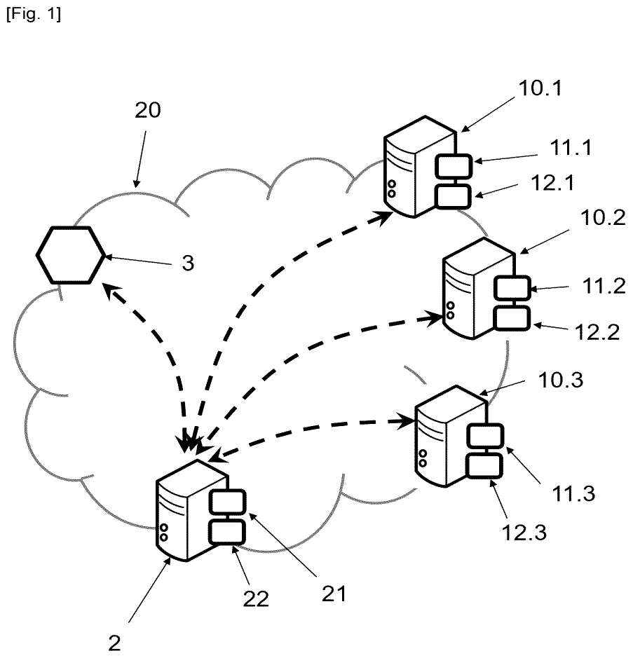

The present invention concerns a method for secure processing of input data from a set of client terminals 10.1, 10.2, 10.3 in a system as shown in FIG. 1.

Said processing is said to be secure because, as we will see, it is implemented in the encrypted domain thanks to the properties of the homomorphic encryption, and in addition it is perfectly anonymous, which means that it is impossible to establish a link between the input data and the terminals 10.1, 10.2, 10.3 from which they originate.

Any processing of interest may be implemented by the present method, such as a comparison between the data, statistical processing, etc.

It is assumed that there is a set of n>1 client terminals 10.1 to 10.3 (3 in FIG. 1), each being a terminal of a user in the broad sense, that is to say an entity holding sensitive data to be processed, for example, a hospital. Each client terminal 10.1, 10.2, 10.3 may be any electronic equipment comprising data processing means 11.1, 11.2, 11.3 such as a processor and data storage means 12.1, 12.2, 12.3 such as memory. Thus, in FIG. 1, the three terminals are, for example, the central servers of three hospitals, and the input data are patient data. It may be useful to implement a processing involving the data of several hospitals, for example, epidemiological statistical calculations, but each hospital wishes to keep its data secret and anonymous (and does not want them to be readable by the other hospitals). However, we will not be limited to this configuration.

For convenience, the general case of n client terminals numbered from 1 to n (10.1 . . . 10.n) will be considered, and

$${D}_{i}^{e}$$

will denote the input data of the i-th terminal denoted 10.i, 0<i≤n, which is assumed to be stored on the storage means 12.i of the i-th terminal 10.i. It is noted that, in the remainder of the description, the indices j, k and I will also be used to denote an integer between 1 and n.

Each client terminal 10.i is connected to a server 2 for implementing the desired processing in the encrypted domain, in particular via a communication network 20 such as the Internet. It also comprises data processing means 21 and data storage means 22. It is assumed that the server 2 belongs to a trusted entity and that it has high calculation power for implementing the secure processing.

The system further comprises a hardware security module 3 connected to said data processing means 21, referred to as the “Hardware Security Module” or simply HSM. This is an apparatus considered to be tamper-proof, offering cryptographic functions and providing a secure execution space called a TEE (“Trusted Execution Environment”), which may be for example an electronic card that may be plugged into a computer or a specific external device, potentially also connected to the server 2 by the network 20, but also a secure enclave of a processor and in particular of the means 21 (for example of the SGX type), i.e., the module 3 may itself form part of the server 2. In a conventional manner, the module 3 comprises a dedicated data storage area.

The present method is implemented by the data processing means 21 of the server 2 as well as the module 3, which share the steps.

It is also assumed that:
each client terminal 10.i is associated with a pair of an encryption key and of a decryption key of the same homomorphic cryptosystem.
the hardware security module 3 is itself associated with a pair of an encryption key and of a decryption key of the homomorphic cryptosystem, called common keys.

We therefore have n+1 key pairs (n terminals and the hardware security module). For convenience, [.]ᵢ denotes data homomorphically encrypted using the encryption key of the i-th terminal 10.i, and [.]* a data homomorphically encrypted using the encryption key of the module 3. Similarly, we have Decᵢ or Dec* the result of an attempt at decryption of a data with the decryption key of the i-th terminal 10.i/of the module 3. By construction of the cryptosystem, we have Decⱼ([x]ᵢ)=x if and only if i=j. Note that we speak of “attempts” at decryption because one can always attempt to apply a decryption key to a data encrypted with a key from another pair, but the result will be scrambled data (indistinguishable from random data, and which no longer contains any information, and therefore from which nothing can be recovered), and we will denote any scrambled data by $, regardless of the actual value of this data. Thus, Decⱼ([x]ᵢ)=$ if i≠j, and similarly [$]ᵢ=$ or Decᵢ($)=$ (for all i, including *). It is noted that the n keys of the terminals are independent, as are the keys of the module: the latter does not need to be derived from the other keys as was sometimes necessary in the prior art.

Preferably and as is known, said cryptosystem is asymmetric, i.e., the encryption keys are public (and therefore potentially known to all the equipment 10.1, 10.2, 10.3, 2, 3) but the decryption keys are private.

In this case, it is assumed that the hardware security module 3 stores each decryption key (those of the n terminals 10.i and its own). It is recalled that the hardware security module 3 is considered tamper-proof and trusted, so there is no issue in entrusting it with the keys.

It is noted that, apart from it, each terminal 10.i has of course its own decryption key (stored on its storage means 12.i) in particular to decrypt results of processing in the encrypted domain according to known techniques which would only involve it, and possibly the decryption key of the module 3 to decrypt the result of the processing.

On the other hand, it is assumed that the server 2 (or at least the non-secure part of the processing means 21) does not have access to any of the decryption keys.

Any cryptosystem that is at least partially homomorphic with respect to the addition may be used, although if the fully homomorphic encryption (FHE) is preferred. For example, there are the RSA cryptosystems which are partially homomorphic, Boneh-Goh-Nissim which is almost fully homomorphic, or Brakerski-Gentry-Vaikuntanathan (BGV), Cheon-Kim-Kim-Son (CKKS), Fast Fully Homomorphic Encryption Over the Torus (TFHE) or even Brakerski-Fan-Vercauteren (BFV) which are totally homomorphic.

It is assumed that the desired processing of the input data is defined by a function f composed of operations compatible with the selected homomorphic cryptosystem, for example a linear function if the cryptosystem is homomorphic with respect to the addition, a polynomial if the cryptosystem is homomorphic with respect to the addition and the multiplication, etc. In the case of an FHE cryptosystem, any function f could theoretically be applied.

### Method

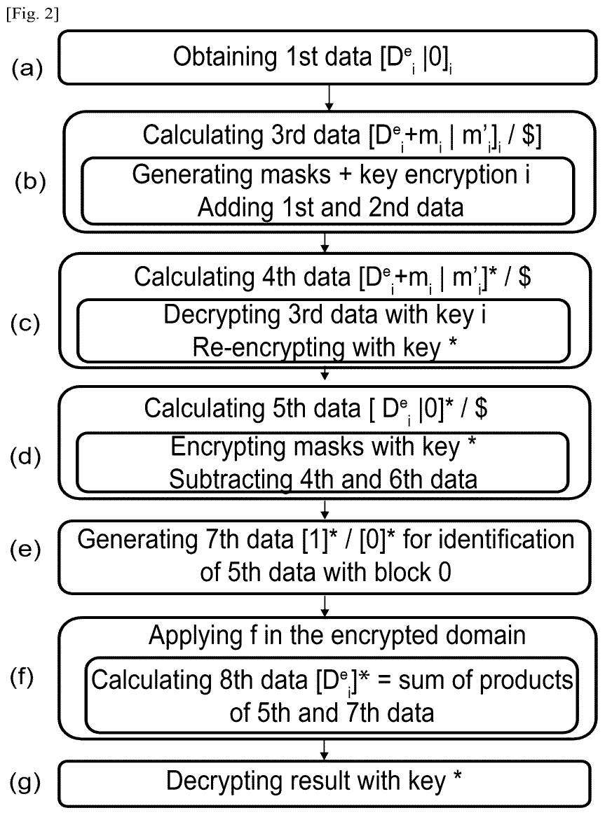

With reference to FIG. 2, the present method begins with a step (a) of obtaining by the data processing means 21 of the server 2, from at least one client terminal 10.i of said set of client terminals 10.1, 10.2, 10.3, a first data corresponding to an input data of said client terminal 10.i padded with a predefined padding block and homomorphically encrypted with the encryption key associated with said client terminal 10.1, 10.2, 10.3.

The server 2 obtains the first data at least for one client terminal, preferably a plurality of client terminals (i.e., a subset of the set of client terminals) or even all client terminals 10.1, 10.2, 10.3.

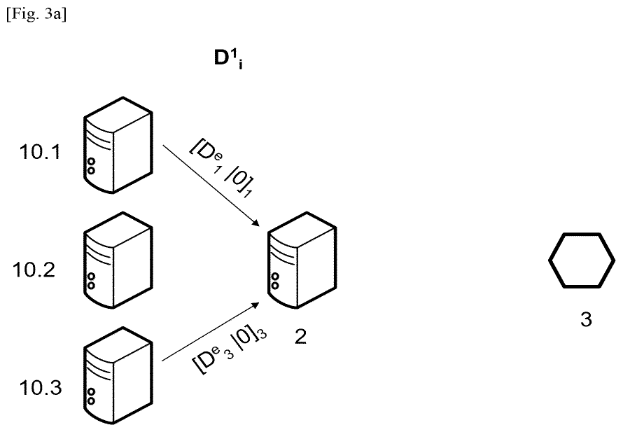

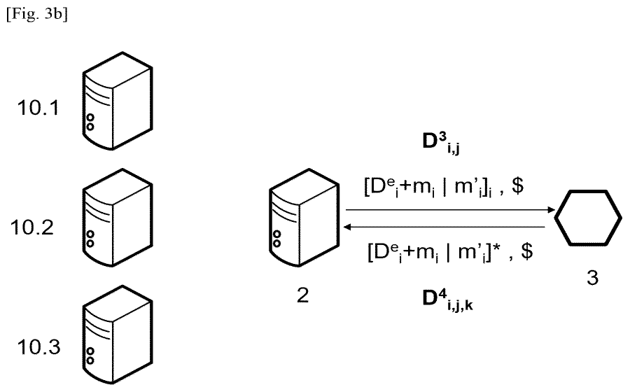

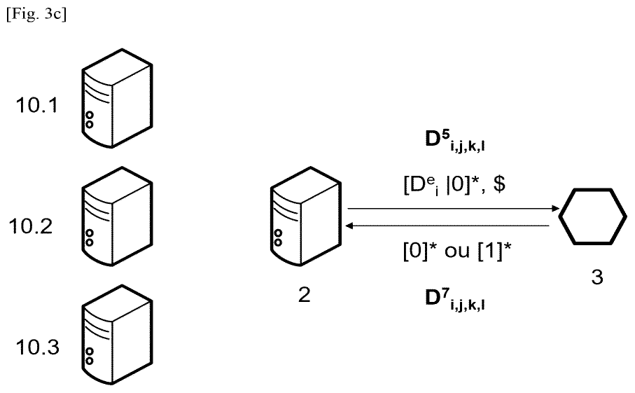

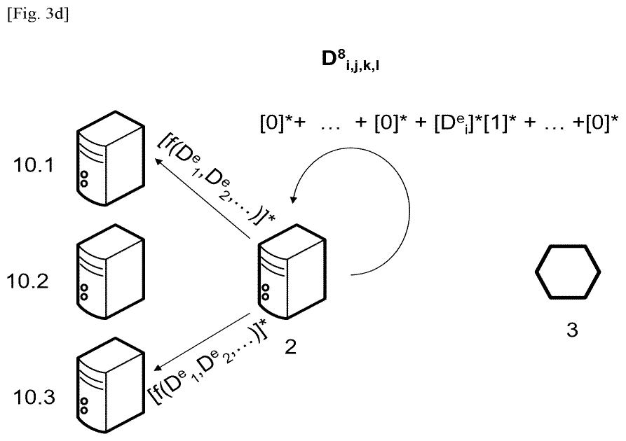

This step (a) is more specifically illustrated by FIG. 3a, in which said subset comprises the terminals 10.1 and 10.3, but not 10.2. m≤n denotes the number of terminals of said subset and M⊆[1; n] the set of indices of the terminals that have provided a first data. We will denote D¹ᵢ, i∈M, the first data obtained for the i-th terminal 10.i.

Step (a) advantageously comprises the generation, by the data processing means 11.i of said client terminal 10.i, of its first data D¹ᵢ, and its transmission to said server 2.

To do this, the client terminal 10.1 starts with its input data D^{e}ᵢ and pads it, i.e. completes it with a predefined padding block. The block is predefined, that is to say that the same block is added (concatened) to each input data, for example, a certain number of zeros. A person skilled in the art can refer, for example, to the document Lightweight FHE-based protocols achieving results consistency for data encrypted under different keys, Marina Checri, Jean-Paul Bultel, Renaud Sirdey, Aymen Boudguiga, who describes such padding.

For convenience, it is noted D^{e}ᵢ|0 the input data padded with the padding block, but it will be understood that we are not limited to the case of zeros and that any arbitrary block could be used for padding.

This data is then homomorphically encrypted with the encryption key associated with said terminal 10.i, i.e., each terminal encrypts the data

$${D}_{i}^{e} \vert 0$$

that it has constructed with its own key.

We obtain m first data

$${D}_{i}^{1} = {[ {D}_{i}^{e} \vert 0 ]}_{i} ,$$

i∈M, in the case

$${[ {D}_{1}^{e} \vert 0 ]}_{1} {and [ {D}_{3}^{e} \vert 0 ]}_{3}$$

### in FIG. 3a.

Next, in step (b), more specifically illustrated by FIG. 3b, for each first data, the data processing means 21 calculate a plurality of third data, each corresponding to the sum of said first data and of a second data corresponding to an element of a set of random masks homomorphically encrypted with the encryption keys associated with each client terminal 10.1, 10.2, 10.3, referred to as the first set for convenience. These are classic additive disposable masks used in cryptography.

We advantageously have a mask, and therefore a second data, for each client terminal 10.1, 10.2, 10.3 of said set, and thus up to n third data generated for each first data, namely up to m*n in total.

Step (b) advantageously begins with the generation, using the means 21, of said set of encrypted random masks (so as to have a new set of masks each time the method is implemented to avoid replays), although this set may be generated beforehand, for example, by randomly selecting n masks from a large set of masks. Step (b) may also comprise, in anticipation of step (d), the generation of another set (referred to as the second set) of the same homomorphically encrypted random masks, this time using the common encryption key, see below.

Preferably, each random mask comprises a first mask part having the same size as the input data, and a second mask part having the same size as the predetermined padding block. Each part may be randomly generated, and the two parts concatenated to obtain the complete mask (or the combination of the two generated at once).

It is noted

$${D}_{j}^{2} ,$$

0<j≤n, the second data generated for the j-th terminal 10.j, mⱼ the first part of the mask and m′ⱼ the second part of the mask for the j-th terminal 10.j, namely a mask mⱼ|m′ⱼ.

Like the first data, each random mask generated for a terminal 10.j is homomorphically encrypted with the encryption key associated with said terminal 10.j, i.e., the means 21 encrypt each data mⱼ|m′ⱼ that they have constructed with the key of the jth terminal 10.j (recall that the encryption keys are public, so there is no problem for this encryption to be carried out by the server 2 rather than the terminal 10.j).

We obtain n second data

$${D}_{j}^{2} = {[ {m}_{j} \vert {m}_{j}^{′} ]}_{j} ,$$

0<j≤n, with said first set expressed as

$$\{ {[ {m}_{j} \vert {m}_{j}^{′} ]}_{j} \} 0 < j \leq n$$

and the second set expressed as

$$\{ {[ {m}_{j} \vert {m}_{j}^{′} ]}^{⋆} \} 0 < j \leq n .$$

A third data, denoted D³_{i,j} is simply the sum of a first data D¹ᵢ and a second data

$${D}_{j \cdot }^{2} ,$$

i.e.,

$${D}_{i , j}^{3} = {D}_{i}^{1} + {D}_{j}^{2} = {[ {D}_{i}^{e} \vert 0 ]}_{i} + {[ {m}_{j} \vert {m}_{j}^{′} ]}_{j} = {[ {D}_{i}^{e} + {m}_{i} \vert {m}_{i}^{′} ]}_{i} if i = j$$

due to the compatibility of the homomorphic encryption with the addition and $ otherwise because it will be impossible to decrypt a data partially encrypted with two keys.

As explained, preferably step (b) comprises the generation of all possible sums, i.e., for each first data and each second data (∀i,j∈M×[1,n]), namely a total of m*n third data. It is noted that only the m

$${D}_{i , i}^{3}$$

such that i=j must necessarily be generated, the others are optional. But the more third data are generated, the more secure the method will be (because the usable data will be buried in the scrambled data—at best, we then have m still usable third data of the form

$${[ {D}_{i}^{e} + {m}_{i} \vert {m}_{i}^{′} ]}_{i}$$

and m(n−1) third scrambled data $).

Step (b) advantageously comprises the transmission of said third data to the hardware security module 3, preferably in a random order.

It is noticed that:
the module 3 cannot distinguish the third data that contains the input data from scrambled data ($);
and even when attempting to decrypt them all, each time the input data are masked;
it is impossible to know which terminal 10.i is associated with each third data.

The security and the anonymity are therefore perfectly preserved, and both the module and the server can only operate “blindly”. However, as we will see, it will still be possible to implement the desired processing.

Thus, the method then comprises in response a step (c), again illustrated by FIG. 3b, of calculation by said hardware security module 3, for each third data, of a plurality of fourth data each corresponding to the result of an attempt at homomorphic cross-encryption of the third data with the encryption key associated with said hardware security module 3, i.e., the common encryption key, assuming successively that the third data has been encrypted with each encryption key associated with one of said client terminals 10.1, 10.2, 10.3.

Cross-encryption (sometimes also referred to as transcryption, or simply re-encryption) is conventionally understood as the act of “changing the encryption key” in practice to arrive at encryption with the common key, but it is important to understand that here it is only an attempt at cross-encryption, insofar as the hardware security module 3 does not know exactly with which encryption key (i.e., with which client terminal 10.1, 10.2, 10.3) each third data has been encrypted. Therefore, in a particularly original and clever way, each cross-encryption is performed “by successively assuming that the third data has been encrypted with several encryption keys associated with one of said client terminals 10.1, 10.2, 10.3”, that is to say blindly, deliberately considering various encryption keys as having been used, including at least one key different from the one actually used.

Of course, the cross-encryption may only work if the assumption is correct, i.e., if the correct encryption key is considered. If, on the other hand, for a third data actually encrypted with a key A, the module 3 incorrectly assumes that it has been encrypted with a key B, the cross-encryption with the common encryption key will only produce noise (scrambled data), hence again the use of the term “attempt” at cross-encryption.

It is thus understood that, for a third data, several fourth data are calculated by successively assuming several encryption keys, that is to say that the different fourth data respectively correspond to the different used encryption key hypotheses, including at least one correct hypotheses is (successful cross-encryption of the third data by assuming that the third data was encrypted with the encryption key actually used to obtain this third data in step (b)) and one incorrect hypothesis (attempt at cross-encryption of the third data by assuming that the third data was encrypted with an encryption key different from the one actually used to obtain this third data in step (b)—in practice, cross-encryption failure).

A simple and preferred way to carry out this cross-encryption is a decryption followed by a new encryption. Then step (c) is more precisely a calculation step by said hardware security module 3, for each third data, of a plurality of fourth data each corresponding to the result of an attempt at homomorphic decryption of the third data with each decryption key stored by the hardware security module 3, itself homomorphically encrypted with the encryption key associated with said hardware security module 3, i.e., the common encryption key.

In other words, step (c), in this preferred mode, comprises for each third data a decryption (with one of the decryption keys associated with the terminals 10.1, 10.2, 10.3, which are stored by the module 3) then an encryption (with its encryption key, which is public or at least stored by the module 3).

It is noted

$${D}_{i , j , k}^{4} ,$$

0<j≤n, the fourth data generated using the decryption key of the k-th terminal 10.k.

$${D}_{i , j , k}^{4} = {[ D e {c}_{k} ( {D}_{i , j )}^{3} ]}^{⋆} = {[ {D}_{i}^{e} + {m}_{i} \vert {m}_{i}^{′} ]}^{⋆}$$

if an only if i=j=k. Indeed, if i≠j we already have

$${D}_{i , j}^{3} = \$$$

and therefore

$${D}_{i , j , k}^{4} = \$$$

for any k, and if i=j but i≠k we decrypt

$${[ {D}_{i}^{e} + {m}_{i} \vert {m}_{i}^{′} ]}_{i}$$

with the wrong key so that the result is still $.

Alternatively, the cross-encryption may be direct, without explicit decryption of the third data, i.e., without returning to the plaintext domain. In other words, the module 3 directly calculates

$${D}_{i , j , k}^{4}$$

from

$${D}_{i , j}^{3} ,$$

without calculating

$${Dec}_{k} ( {D}_{i , j}^{3} ) .$$

Techniques such as proxy re-encryption (PRE) are known in this regard, in which the module 3 does not need to use the decryption key.

It is noted that the decryption embodiment followed by new encryption is preferred because:
this technique does not require high calculation power;
the hardware security module 3 has the decryption keys associated with said client terminals 10.1, 10.2, 10.3, the PRE techniques being specifically designed to avoid having to entrust them to the proxy;
the decryption does not pose a confidentiality problem, since, as repeated, the correct data are masked and buried among the scrambled data.

Preferably, step (c) comprises all possible cross-encryptions, i.e., for every third data, n fourth data are generated (one for the decryption key of each terminal 10.1, 10.2, 10.3: ∀k∈[1,n]), namely a total of up to m*n² fourth data.

Among these, if all possible third data had been generated, then we have m fourth data still usable in the form [D^{e}ᵢ+mᵢ|m′ᵢ]* and m(n²−1) fourth scrambled data $.

Step (c) advantageously comprises the retransmission of said fourth data to the server 2.

At this stage, the server 2 theoretically has all input data homomorphically encrypted under a common key (the encryption key of the module 3), but masked and buried among the scrambled data.

In a clever step (d), more specifically illustrated by FIG. 3c, for each fourth data, the data processing means 21 calculate at least one fifth data corresponding to the difference between said fourth data and a sixth data corresponding to one of said random masks homomorphically encrypted with the encryption key associated with said hardware security module 3.

This step (d) is the counterpart of step (b), the difference is that the masks are encrypted with the common key and a difference is performed instead of a sum. It is thus understood that the second set mentioned earlier is used, and that each sixth data corresponds to an element of said second set.

Advantageously, we have a sixth data for each mask (i.e., a sixth data for each second data), and therefore preferably again one for each client terminal 10.1, 10.2, 10.3 of said set.

According to a first variant, the fifth data calculated for a fourth data corresponds to the difference between said fourth data and the sixth data corresponding to the same random mask as the second data from which this fourth data was calculated. To rephrase, for each fourth data, the data processing means 21 calculate in step (d) exactly a fifth data corresponding to the difference between said fourth data and the sixth data corresponding to said random mask associated with the second data used in the calculation of this fourth data, this time homomorphically encrypted with the encryption key associated with said hardware security module 3.

Indeed, if no random permutation has yet been implemented at this stage (said third data have not been transmitted to the hardware security module 3 in a random order), the processing means 21 may be able to establish a link between the third data and the fourth data and it is enough to remove the correct mask from each fourth data, i.e., we have as many fifth data obtained as fourth data (m*n²).

According to a second variant, step (d) comprises the calculation of a plurality of fifth data corresponding to all possible differences between said fourth data and a sixth data corresponding to one of said plurality of random masks homomorphically encrypted with the encryption key associated with said hardware security module 3 (i.e., each element of the second set).

Indeed, in particular if a random permutation has occurred, and the processing means 21 have thus lost track of the original third data, all possible differences are calculated, resulting in up to n sixth data generated for each fourth data, i.e., up to m*n³ in total. This can even be done in the absence of a random permutation simply to increase the number of scrambled data.

Step (d) advantageously begins with the generation by the means 21 of said sixth data (the second set), which may alternatively be generated at the same time as the second data (in step (b)), or even earlier.

It is noted

$${D}_{l}^{6} ,$$

0<l≤n, the sixth data generated for the l-th terminal 10.l, with again mₗ the first part of the mask and m′ₗ the second part of the mask for the l-th terminal 10.l, namely a mask

$${m}_{l} \vert {m}_{l}^{′} .$$

It is recalled that these are indeed the same masks as in step (b).

Like the fourth data, each random mask generated for a terminal 10.1 is homomorphically encrypted with the common encryption key, that is to say the one associated with said module 3, i.e., the means 21 encrypt each data

$${m}_{l} \vert {m}_{l}^{′}$$

that they have constructed with the key of the module 3 (it is recalled that the encryption keys are public).

N sixth data

$${D}_{l}^{6} = {[ {m}_{l} \vert {m}^{′} l ]}^{⋆} ,$$

0<l≤n, are obtained. As explained, if the means 21 know how to link them with the third data we can for each fourth data

$${D}_{i , j , k}^{4}$$

use the unique sixth data

$${D}_{j}^{6} = {[ {m}_{j} \vert {m}_{j}^{′} ]}^{⋆} ,$$

i.e., take l=j.

A fifth data, denoted

$${D}_{i , j , k , l}^{5} ,$$

is simply the difference between a fourth data

$${D}_{i , j , k}^{4}$$

and a sixth data

$${D}_{l}^{6} ,$$

i.e.,

$${D}_{i , j , k , l}^{5} = {D}_{i , j , k}^{4} - {D}_{l}^{6} = {[ {D}_{i}^{e} + {m}_{i} \vert {m}_{i}^{′} ]}^{⋆} - {[ {m}_{j} \vert {m}_{j}^{′} ]}^{⋆} = {[ {D}_{i}^{e} \vert 0 ]}^{⋆}$$

if i=j=k=l due to the compatibility of the homomorphic encryptions with the addition, and $ otherwise because:
either already

$${D}_{i , j , k}^{4} = \$$$

or, if we calculate all the differences, i=i=k but i≠l, and then we mix masks, i.e.,

$${D}_{i , j , k , l}^{5} = {[ {D}_{i}^{e} + {m}_{i} \vert {m}_{i}^{′} ]}^{*} - {[ {m}_{l} \vert {m}_{l}^{′} ]}^{*} = {[ {D}_{i}^{e} + {m}_{i} - {m}_{l} \vert {m}_{i}^{′} - {m}_{l}^{′} ]}^{*} = \$$$

because mᵢ≠mₗ and m′ᵢ≠m′ₗ due to their random selection.

If all possible fourth data had been generated, then we recover the m fifth data of the form [D^{e}ᵢ|0]* corresponding to the m input data encrypted under common key instead of their specific keys and up to m(n³−1) fourth scrambled data $ if we have calculated n fifth data per fourth data.

Step (d) advantageously comprises the transmission of said fifth data to the hardware security module 3, preferably still in a random order.

As at the end of step (b), its noticed that:
the module 3 cannot distinguish the fifth data that contain the input data from those that are scrambled ($);
if they are transmitted (and this remains optional, see just after), the input data are no longer masked but buried among a very large number of scrambled data whose order has been mixed up several times so that it is not statistically possible to find them;
it is still impossible to know which terminal 10.i is associated with each fifth data.

Alternatively, step (d) may comprise only the transmission of the padding blocks of said fifth data to the hardware security module 3, preferably still in a random order, which makes it completely impossible for the module 3 to read the input data in plaintext.

In step (e), the module 3 will be able to “sort” the usable fifth data from the scrambled ones, while maintaining anonymity. Indeed, at this stage, the input data are encrypted with the same key, making processing within the encrypted domain possible, but it must be located among the scrambled data.

More specifically, in step (e), for each fifth data, the hardware security module 3 identifies those fifth data comprising a padding block coinciding with said predefined padding block (in other words terminated by bits that are the same as those of said predefined block, for example a certain number of zeros).

This step (e) generally comprises the homomorphic decryption of the received data (either the entire fifth data, or just their padding blocks) using the decryption key of the module 3 (which is known only to the latter—as well as possibly to the client terminals 10.1, 10.2, 10.3, but which remains private and, in any case, not known to the server 2).

Step (e) may then be implemented in many ways:
If only the padding blocks have been transmitted, it is sufficient to directly compare the decryption result with the expected block, for example a sequence of zeros. For any scrambled data $, the result will be different (with an error probability equal to ½\hat{ } (number of zeros), which becomes rapidly becoming negligible);
If the fifth data has been transmitted, the padding block may be decrypted and then extracted;
Next, according to a first embodiment, the module 3 generates, for each fifth data, a seventh data denoted

$${D}_{i , j , k , l}^{7}$$

(thus there are as many seventh data as fifth data, namely up to m*n³) having a first value if the fifth data comprises a padding block coinciding with said predefined padding block, and a second value otherwise. As shown in FIG. 3c, these are preferably two encrypted bits, in other words, the first value is preferably 1, homomorphically encrypted with the encryption key of the module 3 (i.e., [1]*), and the second value is preferably 0, homomorphically encrypted with the encryption key of the module 3 (i.e., [0]*), which facilitates the calculations, although any other pair of different values may be used. To summarize, in the preferred mode we have

$${D}_{i , j , k , l}^{7} = {[ 1 ]}^{*} if {D}_{i , j , k , l}^{5} = {[ {D}_{i}^{e} \vert 0 ]}^{⋆}$$

(which is the case if and only if i=j=k=l) and

$${D}_{i , j , k , l}^{7} = {[ 0 ]}^{⋆} if {D}_{i , j , k , l}^{5} = \$$$

(the other cases). Step (e) then advantageously comprises the retransmission of all seventh data to the server 2.
According to a second embodiment, in particular if all fifth data have been transmitted, the module 3 simply returns to the server 2 the set of fifth data identified as comprising a padding block coinciding with said predefined padding block (numbering m), either in full or directly with their padding block removed (i.e., the left part—the module 3 may simply separate the left and right parts of each fifth data and return the left parts encrypted under the common key

$${[ {D}_{i}^{e} ]}^{⋆}$$

when the right part coincides with the predefined padding block). The others (the $) are not returned. It is noted, however, that the first embodiment allows the protection to be maintained through the mass of data, since m*n³ seventh data are transmitted, the majority of which are scrambled.

It should be noted that the number of operations implemented by the hardware security module 3 may appear excessively heavy, since it has a complexity of O(n⁴). However, in practice, the value of n remains consistently low (on the order of tens or, at worst, hundreds) since it designates the number of entities wishing to implement common secure processing operations, such as a group of hospitals. Thus, a complexity of O(n⁴) is not at all problematic in view of the advantages provided in terms of security and anonymity.

Finally, the method comprises a step (f) of applying, by the processing means 21, in the encrypted domain, a function corresponding to the desired processing to the identified fifth data.

It is recalled that the desired processing is defined by a function denoted f, and the objective is to apply f to the input data D^{e}ᵢ. The step (f) consists in homomorphically evaluating f on the [D^{e}ᵢ]*, that is to say in the encrypted domain and not on the plaintext data, which the server 2 does not possess: due to the properties of homomorphic encryption, we have

$$f ( {[ {D}_{1}^{e} ]}^{⋆} , {[ {D}_{2}^{e} ]}^{*} , {… [ {D}_{m}^{e} ]}^{⋆} ) = {[ f ( {D}_{1}^{e} , {D}_{2}^{e} , … {D}_{m}^{e} ) ]}^{⋆} .$$

It should be noted that this processing may be computationally complex, but the server 2 may be selected based on the performance of its means 21 without any security risk since it operates in the encrypted domain and does not possess any decryption key. A piece of data is thus obtained, which will be referred to for convenience as ninth data, which in practice corresponds to the encryption of the expected result.

Step (f) can be implemented in many different ways depending on the nature of step (e):
if the module 3 has directly returned the identified fifth data as comprising a padding block coinciding with said predefined padding block, or even only their left parts, these may be extracted and directly injected into the function f;
if the module 3 has returned, for each fifth data, a first or second value depending on whether the fifth data comprises a padding block coinciding with said predefined padding block, it suffices to take the left parts of the fifth values for which the first value has been returned;
a very clever way of implementing this latter action, when the first value is [1]* and the second value is [0]*, and when the homomorphic encryption is compatible with the multiplication, is, as illustrated in FIG. 3d, simply to calculate for each first data (i.e. for each input data, that is to say for each client terminal 10.i) an eighth data (m in total) corresponding to the sum of the products of each fifth data without its padding block (the left part) by the corresponding seventh data (the one returned for this fifth data).

Indeed,

$${{[ {D}_{i}^{e} ]}^{⋆} [ 1 ]}^{⋆} = {[ {D}_{i}^{e} \times 1 ]}^{⋆} = {[ {D}_{i}^{e} ]}^{⋆}$$

and [$]* [0]*=[$×0]*=[0]* due to the properties of homomorphic encryption.

Mathematically, denoting

$${D}_{i}^{8}$$

as the eighth data, we have

$${D}_{i}^{8} = \sum j \sum k {\sum }_{l} ( {D}_{i , j , k l}^{7} \times left ( {D}_{i , j , k , l}^{5} ) ) ,$$

each term being equal either to

$${[ {D}_{i}^{e} ]}^{*} if i = j = k = l$$

(because then

$${D}_{i , j , k , l}^{7} = {[ 1 ]}^{*} )$$

and [0]* otherwise (because then

$${D}_{i , j , k , l}^{7} = {[ 0 ]}^{*} ) ,$$

so that

$${D}_{i}^{8} = {[ 0 ]}^{⋆} + {[ 0 ]}^{⋆} + … + {[ 0 ]}^{⋆} + {[ {D}_{i}^{e} ]}^{⋆} + {[ 0 ]}^{⋆} + … + {[ 0 ]}^{⋆} = {[ {D}_{i}^{e} ]}^{⋆}$$

It is then sufficient to calculate

$$f ( {D}_{1}^{8} , {D}_{2}^{8} , … {D}_{m}^{8} ) = f ( {[ {D}_{1}^{e} ]}^{⋆} , {[ {D}_{2}^{e} ]}^{⋆} , {… [ {D}_{m}^{e} ]}^{⋆} ) = {[ f ( {D}_{1}^{e} , {D}_{2}^{e} , … {D}_{m}^{e} ) ]}^{⋆} ,$$

which corresponds to said ninth data.

It is noted that at this stage, the ninth data is still in the encrypted domain, it can be transmitted freely without risk of disclosure of confidential data.

Thus, the method advantageously comprises a step (g) of homomorphic decryption of said result of the application of the function (the ninth data) by a holder of the decryption key associated with the hardware security module 3, either by the hardware security module 3 itself, or, for example, by one of the client terminals 10.1, 10.2, 10.3 if this decryption key has been entrusted to them, where applicable with the retransmission of the result (case represented by FIG. 3d), so as to obtain

$$f ( {D}_{1}^{e} , {D}_{2}^{e} , … {D}_{m}^{e} )$$

in plaintext. The use thereof is not limited to any specific application.

It should be noted that step (g) may further comprise the application of a complementary function f′ to the decryption result, for example for more complex processing, particularly non-linear processing, if the complementary function comprises operations that are not compatible with the homomorphic cryptosystem.

### Server

According to a second aspect, the invention concerns the set of the server 2 and the hardware security module 3 for implementing the method according to the first aspect.

As explained, the server 2 comprises data processing means 21 and data storage means 22 (which may in particular store the homomorphic encryption keys of the terminals 10.1, 10.2, 10.3 and the module 3—it being recalled that these keys are generally public, but generally no decryption keys). The module 3, for its part, stores all the decryption keys.

The hardware security module 3 can in practice be integrated into the server 2 or may even constitute a secure enclave of the processing means 21.

The server 2 and/or the module 3 are preferentially connected to terminals 10.1, 10.2, 10.3 for example via a network 20 such as the internet.

The data processing means 21 are configured to implement steps consisting of:
Obtaining, from at least one client terminal a set of client terminals 10.1, 10.2, 10.3 each associated with a pair of an encryption key and a decryption key stored by a hardware security module 3 connected to said data processing means 21, a first data corresponding to an input data of said client terminal 10.1, 10.2, 10.3 padded with a predefined padding block and homomorphically encrypted with the encryption key associated with said client terminal 10.1, 10.2, 10.3;
For each first data, calculating a plurality of third data, each corresponding to the sum of said first data and a second data corresponding to an element of a set of random masks homomorphically encrypted with the encryption keys associated with each client terminal 10.1, 10.2, 10.3;
For each fourth data, calculating at least one fifth data corresponding to the difference between said fourth data and a sixth data corresponding to one of said random masks homomorphically encrypted with the encryption key associated with said hardware security module 3;
Applying in the encrypted domain a function corresponding to the desired processing from identified fifth data.

The module 3 is configured to implement steps consisting of:
For each third data, calculating a plurality of fourth data, each corresponding to the result of an attempt at homomorphic decryption of the third data with each decryption key associated with one of said client terminals 10.1, 10.2, 10.3 stored by the hardware security module 3, the result being homomorphically encrypted with an encryption key associated with said hardware security module 3;
For each fifth data, identifying the fifth data comprising a padding block coinciding with said predefined padding block.

The invention also proposes the system comprising the server 2, the hardware security module 3 and the set of client terminals 10.1, 10.2, 10.3 connected via the network 20.

The client terminals 10.1, 10.2, 10.3 comprise data processing means 11.1, 11.2, 11.3 and data storage means 12.1, 12.2, 12.3, each storing at least the input data specific to its terminal, the (private) decryption key associated with its terminal and potentially the decryption key associated with the module 3.

The data processing means 11.1, 11.2, 11.3 of each terminal 10.1, 10.2, 10.3 are advantageously configured to implement the steps consisting of:
Generating the first data corresponding to the input data of said client terminal 10.1, 10.2, 10.3, padded with a predefined padding block and homomorphically encrypted with the encryption key associated with said client terminal 10.1, 10.2, 10.3
decrypting said result of the application of the function with the decryption key associated with the hardware security module 3.

### Computer Program Product

According to a third and a fourth aspect, the invention relates to a computer program product comprising code instructions for executing (on the data processing means 21 of the server 2 and/or the hardware security module 3) a method according to the first aspect of secure processing of input data, as well as computer-readable storage means (for example the data storage means 22 of the server 2 and/or the hardware security module 3) on which this computer program product is stored.

1. A method for secure processing input data, the method comprising:
(a) obtaining by data processing means of a server, from at least one client terminal of a set of client terminals each associated with a pair of an encryption key and a decryption key stored by a hardware security module connected to said data processing means, a first data corresponding to an input data of said client terminal padded with a predefined padding block and encrypted homomorphically with the encryption key associated with said client terminal;
(b) for each first data, calculating by the data processing means, a plurality of third data each corresponding to a sum of said first data and a second data corresponding to a random mask from a set of random masks homomorphically encrypted with the encryption keys associated with each client terminal;
(c) for each third data, calculating by said hardware security module a plurality of fourth data, each corresponding to the result of an attempt at homomorphic cross-encryption of the third data with an encryption key associated with said hardware security module, assuming successively that the third data has been encrypted with several encryption keys associated with one of said client terminals;
(d) for each fourth data, calculating by the data processing means at least a fifth data corresponding to the difference between said fourth data and a sixth data corresponding to one of said random masks homomorphically encrypted with the encryption key associated with said hardware security module;
(e) identifying by the hardware security module the fifth data comprising a padding block coinciding with said predefined padding block; and
(f) applying by the processing means in the encrypted domain a function corresponding to the desired processing from the fifth identified data, said function being composed of operations compatible with said homomorphic encryption.

2. The method according to claim 1, wherein the encryption keys are public and the decryption keys are private.

3. The method according to claim 1, wherein said homomorphic encryption is of totally homomorphic type, FHE.

4. The method according to claim 1, wherein the step (a) comprises the generation by data processing means of said client terminal of the first data and its transmission to said server.

5. The method according to claim 1, wherein the step (b) comprises the transmission to the hardware security module in a random order of the plurality of third data; and/or step (d) comprises the transmission to the hardware security module in a random order of the plurality of fifth data or the padding blocks of the plurality of fifth data.

6. The method according to claim 1, wherein the fifth data calculated for a fourth data corresponds to the difference between said fourth data and the sixth data corresponding to the same random mask as the second data from which this fourth data was calculated.

7. The method according to claim 1, wherein the steps (b), (c), and (d) respectively comprise the calculation of all possible third data, all possible fourth data, and all possible fifth data.

8. The method according to claim 1, wherein the step (e) comprises, for each fifth data, the generation by the hardware security module of a seventh data denoted having a first value if the fifth data comprises a padding block coinciding with said predefined padding block, and a second value otherwise.

9. The method according to claim 8, wherein said first value of the seventh data is the value 1 homomorphically encrypted with the encryption key associated with said hardware security module, and the second value of the seventh data is the value 0 homomorphically encrypted with the encryption key associated with said hardware security module.

10. The method according to claim 9, wherein the step (f) comprises, for each first data, the calculation of an eighth data corresponding to the sum of each of the products of a fifth data calculated from this first data, without the padding block, by the seventh data calculated for this fifth data.

11. The method according to claim 10, wherein the step (f) comprises the application of said function directly to the eighth data.

12. The method according to claim 1, wherein said hardware security module is a secure enclave of the data processing means.

13. The method according to claim 1, wherein the step (a) comprises the obtention of a plurality of first data from a subset of client terminals of said set of client terminals.

14. The method according to claim 1, further comprising a homomorphic decryption step (g) by the hardware security module and/or at least one of the client terminals, of said result of the application of the function with the decryption key associated with the hardware security module.

15. The method according to claim 1, wherein each fourth data calculated in the step (c) corresponds to the result of an attempt at homomorphic decryption of the third data with each decryption key associated with one of said client terminals stored by the hardware security module, homomorphically encrypted with the encryption key associated with said hardware security module.

16. A system of a server and a hardware security module for secure processing of input data, wherein:
the server comprises data processing means configured to:
obtain, from at least one client terminal of a set of client terminals each associated with a pair of an encryption key and a decryption key stored by a hardware security module connected to said data processing means, a first data corresponding to an input data of said client terminal padded with a predefined padding block and homomorphically encrypted with the encryption key associated with said client terminal;
for each first data, calculate a plurality of third data, each corresponding to a sum of said first data and a second data corresponding to an element of a set of random masks homomorphically encrypted with the encryption keys associated with each client terminal;
for each fourth data, calculate at least one fifth data corresponding to the difference between said fourth data and a sixth data corresponding to one of said random masks homomorphically encrypted with the encryption key associated with said hardware security module; and
apply in the encrypted domain a function corresponding to the desired processing from identified fifth data, said function being composed of operations compatible with said homomorphic encryption; and
the hardware security module is configured to:
for each third data, calculate a plurality of fourth data, each corresponding to the result of an attempt at homomorphic cross-encryption of the third data with an encryption key associated with said hardware security module, assuming successively that the third data has been encrypted with each encryption key associated with one of said client terminals; and
for each fifth data, identify the fifth data comprising a padding block coinciding with said predefined padding block.

17. A non-transitory computer-readable medium comprising code instructions for the execution of the method according to claim 1 of secure processing of input data, when said program is executed on a computer.

18. A non-transitory computer-readable storage means on which is recorded a computer program product comprising code instructions for the execution of the method according to claim 1 of secure processing of input data.
